(19) United States
(12) Patent Application Publication
(10) Pub. No.: US 2013/0314070 A1
(43) Pub. Date: Nov. 28, 2013

(54) DC-DC CONVERTER

(71) Applicant: KABUSHIKI KAISHA TOSHIBA, Tokyo (JP)

(72) Inventors: Naoto SHINOHARA, Yokohama-shi (JP); Kazunobu NAGAI, Yokohama-shi (JP)

(73) Assignee: Kabushiki Kaisha Toshiba, Tokyo (JP)

(21) Appl. No.: 13/790,164

(22) Filed: Mar. 8, 2013

(30) Foreign Application Priority Data
May 25, 2012 (JP) 2012-119740

(51) Int. Cl. G05F 3/24

(52) U.S. Cl. CPC G05F 3/24
USPC 323/351

(57) ABSTRACT

A DC-DC converter includes a main reactor interposed in a main energization path extending from a DC voltage input terminal to a DC voltage output terminal, a first main switching element interposed into the main energization path so as to be on-off controlled so that current flowing across the main reactor is intermitted, a second main switching element forming a discharge loop discharging electrical energy stored in the main reactor to the DC voltage output terminal side, an auxiliary reactor interposed between the first main switching element and the main reactor in the main energization path, an auxiliary switching element discharging electrical energy via the main reactor to the DC voltage output terminal side, the electrical energy being stored in the auxiliary and main reactors, and diodes connected in reverse parallel with the first and second main switching elements and the auxiliary switching elements respectively.

### CROSS-REFERENCE TO RELATED APPLICATIONS

This application is based upon and claims the benefit of priority from the prior Japanese Patent Application No. 2012-119740 filed on May 25, 2012, the entire contents of both of which are incorporated herein by reference.

### FIELD

Embodiments described herein relate to a DC-DC converter which converts DC input voltage having a voltage value to DC output voltage having another voltage value.

### BACKGROUND

A DC-DC converter has a function of converting DC voltage supplied from a DC power source to DC voltage having a different voltage value by step-up or step-down of the supplied DC voltage. The DC-DC converter also has another function of stabilized DC power supply by addition of a feedback function and PWM control. The DC-DC converter is generally composed into a DC chopper circuit comprising two switching elements, a single reactor and a freewheeling diode. Basically, first and second main switching elements are serially connected between positive and negative terminals of the DC power source. The reactor is connected via a load in parallel to the second switching element disposed at the negative side. A snubber diode or a freewheeling diode is connected in parallel to each switching element. The first and second main switching elements are on-off controlled alternately. DC current is supplied from the DC power source via the reactor to the load during an on period of the first main switching element. Electric energy due to back-electromotive force is stored in the reactor when the first switching element is turned off.

The stored energy serves as current circulating a closed loop formed by turn-on of the second switching element concurrently with turn-off of the first switching element. The current is discharged as DC current to the load. In the DC-DC converter configured as described above, the first and second main switching elements are connected in series to each other between the positive and negative terminals of the DC power source. Accordingly, if there should be a simultaneous turn-on time with respect to both switching elements, short-circuit current would break the elements. For the purpose of preventing this, the switching elements are controlled so as to be turned on or off upon lapse of a time period in which both switching elements are turned off (dead time).

There is also a problem of short circuit current due to recovery current aside from the short circuit current which can be prevented by application of dead time. There has conventionally been provided a technique for suppressing occurrence of recovery current in resonant DC-DC converters. Recovery current refers to a large instantaneous current flowing in a reverse direction across the snubber diode or the freewheeling diode each of which is connected in reverse parallel with the switching element as described above. When the switching element is turned off, reverse voltage is applied to the diode thereby to block current flow. However, residual carrier stored in the diode causes reverse current to flow instantaneously. The reverse current is referred to as “recovery current.” The recovery current short-circuits the paired series-connected switching elements with the result that a large instantaneous short-circuit current fluctuates DC output voltage or noise is produced.

The short-circuit current resulting from recovery current has a sharp needle-shaped waveform to result in large surge voltage, which induces intense noise. When the DC-DC converter is used in vehicles, the short-circuit current fluctuates a body chassis potential, enlarges control errors and increases switching loss. The short-circuit current thus results in various failures. The above-described type DC-DC converters are most frequently used as DC power supply circuits of portable electrical equipment. It has been strongly desired to eliminate the failures resulting from the short circuit current due to the recovery current.

### BRIEF DESCRIPTION OF THE DRAWINGS

FIG. 1 is a circuit diagram of a DC-DC converter according to a first embodiment;

FIG. 2 is a schematic graph showing voltage current waveforms in the first embodiment;

FIG. 3 is a circuit diagram of a DC-DC converter according to a second embodiment; and

FIG. 4 is a schematic graph showing voltage current waveforms in the second embodiment.

### DETAILED DESCRIPTION

In general, according to one embodiment, a DC-DC converter comprises a main reactor interposed in a main energization path extending from a DC voltage input terminal to a DC voltage output terminal. A first main switching element is interposed into the main energization path so as to be on-off controlled so that current flowing across the main reactor is intermitted. A second main switching element forms a discharge loop which discharges electrical energy stored in the main reactor to the DC voltage output terminal side. An auxiliary reactor is interposed between the first main switching element and the main reactor in the main energization path. An auxiliary switching element discharges electrical energy via the main reactor to the DC voltage output terminal side. The electrical energy is stored in the auxiliary and main reactors. A plurality of diodes is connected in reverse parallel with the first and second main switching elements and the auxiliary switching elements respectively.

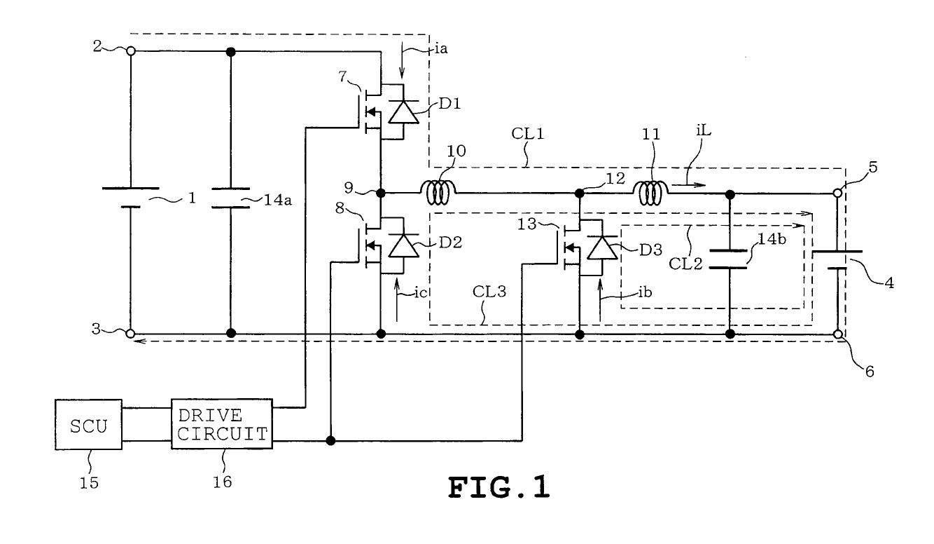

Embodiments will be described with reference to the accompanying drawings. Referring first to FIG. 1, a DC-DC converter according to a first embodiment is shown in the form of an electrical circuit. The DC-DC converter includes an input side and an output side. The DC-DC converter has, in the input side, a DC voltage positive input terminal 2 and a DC voltage negative input terminal 3 both to be connected to a DC power source 1 and, in the output side, a DC voltage positive output terminal 5 and a DC voltage negative output terminal 6 both to be connected to a load 4. The terms, “positive” and “negative” merely signify potential levels in a relative manner. The DC power source 1 may include batteries and AC-DC conversion rectifier circuits. The load 4 may include a resistive load, an inductive load such as electric motors, rechargeable batteries and similar devices.

A first main switching element 7 and a second main switching element 8 are connected in series to each other between the DC voltage positive and negative input terminals 2 and 3, so as to be located at the positive side and the negative side respectively. An auxiliary reactor 10 and a main reactor 11 are connected in series to each other between a common connection point 9 of both switching elements 7 and 8 and the DC voltage positive output terminal 5, so as to be located at the common connection point 9 side and the DC voltage positive output terminal 5 side respectively. A second main switching element 13 is connected between a common connection point 12 of both reactors 10 and 11 and the DC voltage negative output terminal 6. A smoothing capacitor 14a is connected between the DC voltage positive and negative input terminals 2 and 3, and another smoothing capacitor 14b is connected between the DC voltage positive and negative output terminals 5 and 6.

Diodes D1, D2 and D3 are connected in reverse parallel with the switching elements 7, 8 and 13 respectively. The switching elements 7, 8 and 13 are FETs respectively, for example. Since a diode part is parasitic in an EFT, the diodes D1, D2 and D3 shown in FIG. 1 are parasitic diodes. The switching elements maybe elements in which no diodes are parasitic, such as bipolar transistors. In this case, the diodes D1, D2 and D3 are externally connected to the transistors or elements.

The auxiliary reactor 10 has inductance that is substantially hundredth part of that of the main reactor 11 and a time constant that is selected so as to be not more than one period of an on-off cycle of the first main switching element 7. The auxiliary reactor 10 has a smaller current capacity than the main reactor 11, and it is desirable that the current capacity of the auxiliary reactor 10 be substantially not more than 75% of that of the main reactor 11. Furthermore, the auxiliary switching element 8 may also have a smaller value of current capacity than the first main switching element 7.

The DC-DC converter further includes a switching control unit (SCU) 15 for on-off controlling the switching elements 7, 8 and 13. The SCU 15 is configured with a microcomputer and generates gate control signals, which are supplied via a gate drive circuit 16 to gates of the switching elements 7, 8 and 13 respectively. The SCU 15 performs a PWM control with respect to the first and second switching elements 7 and 13 in a manner well known in the art, so that a voltage between the DC voltage positive and negative terminals 5 and 6 is maintained at a target value, although a configuration for this purpose is not shown in detail in the drawings.

In the above-described connecting configuration, the auxiliary and main reactors 10 and 11 are interposed in a main energization path extending from the DC voltage positive input terminal 2 to the DC voltage positive output terminal 5. Electric current flowing through the auxiliary and main reactors 10 and 11 is intermitted by the first main switching element 7 interposed in the main energization path. The resultant intermittent current causes both reactors 10 and 11 to generate back electromotive force, whereupon electrical energy is stored. The electrical energy stored in the main reactor 11 is discharged in the direction of the DC voltage positive output terminal 5 by turn-on of the second main switching element 13, while electrical energy stored in the auxiliary reactor 10 is discharged via the reactor 11 in the direction of the DC voltage positive output terminal by turn-on of the auxiliary switching element 8.

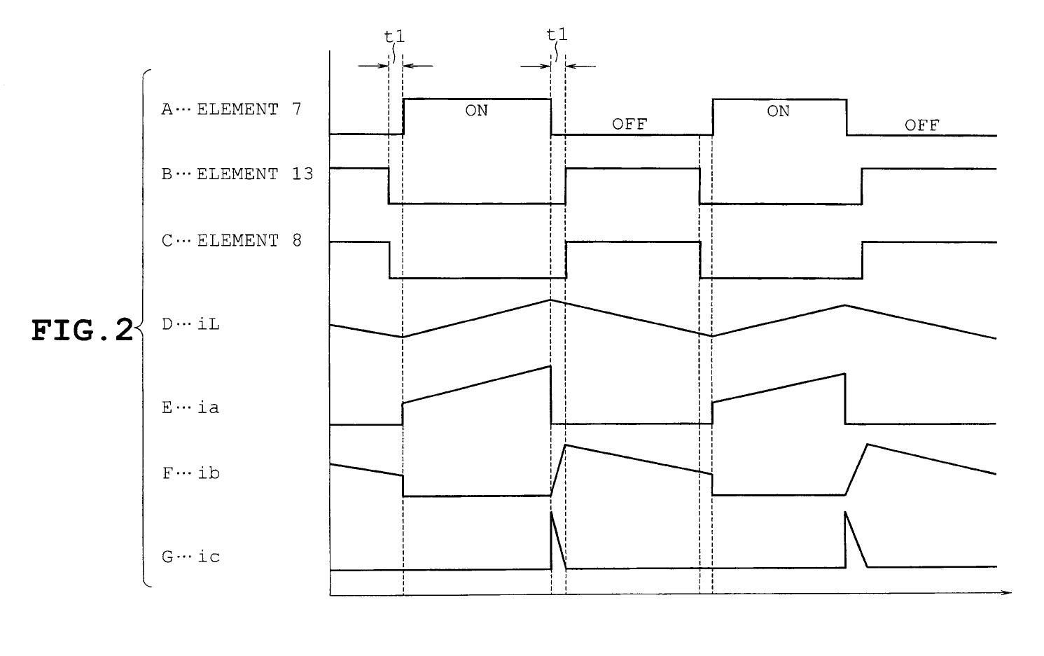

The working of the DC-DC converter thus configured will be described in detail as follows with reference to FIG. 2. The first and second main switching elements 7 and 13 are on-off controlled alternately as shown in FIG. 2-(A) and 2-(B) respectively. In this case, the elements 7 and 13 have such a relationship that the element 13 is in an off-time when the element 7 is in an on-time. In other words, the elements 7 and 13 have phases opposed to each other. However, in order that both switching elements 7 and 13 may be prevented from being simultaneously turned on, dead time t1 is provided before turn-on of the first main switching element 7 and dead time t1 is also provided after turn-off of the first main switching element 7.

Upon turn-on of the first main switching element 7, a closed loop CL1 is formed so that DC current flows through the first main switching element 7, the auxiliary reactor 10 and the main reactor 10 sequentially to the load 4 side. Part D of FIG. 2 (hereinafter, “FIG. 2-D”) shows current iL flowing through the main reactor 11 in this case. The current iL flowing through the main reactor 11 is gradually increased during an on-period of the first main switching element 7 by a self-induced action as shown in FIG. 2-D, whereupon electrical energy as back-electromotive force is stored.

When the first main switching element 7 transits to an off period, the second main switching element 13 transits to an on period, so that a closed loop (a discharge loop) CL2 is formed by the second main switching element 13, the main reactor 11 and the load 4. Electric energy stored by the main reactor 11 is discharged via the closed loop CL2 to the load 4 as shown in FIG. 1 and by current ib in FIG. 2-F. Thus, the first and second main switching elements 7 and 13 are on-off controlled so that the DC voltage is continually applied to the load 4. FIG. 2-E shows current is passing through the first main switching element 7 in the above-described operation.

In parallel with the foregoing operation, the auxiliary switching element 8 is on-off controlled simultaneously with the second main switching element 13 as shown in FIG. 2-C. When the auxiliary switching element 8 is turned on, a closed loop (a discharge loop) CL3 is formed by the auxiliary switching element 8, the auxiliary reactor 10, the main reactor 11 and the load 4. As a result, since the first main switching element 7 is turned on, the electrical energy stored by the auxiliary reactor 10 is discharged via the main reactor 11 to the load 4 in the closed loop CL3. FIG. 2-G shows current is passing though the auxiliary switching element 8 in this case.

The following describes suppression of short-circuit current by recovery current. The diodes D1 and D2 are connected in reverse parallel with the first and second main switching elements 7 and 13 respectively. The main switching elements 7 and 13 transit from an ON state to an OFF state, with the result that reverse bias voltage is applied to the diodes D1 and D2. However, the diodes D1 and D2 cannot be turned off since residual carriers remain in the diodes D1 and D2. The residual carriers cause recovery current to flow from the DC voltage positive input terminal 2 immediately when the first and second main switching elements 7 and 13 are each turned to an OFF state (dead time t1 in FIG. 2). The recovery current flows through the diode D1, the auxiliary reactor 10 and the diode D3 to the DC voltage negative output terminal 6.

In the foregoing embodiment, however, the auxiliary reactor 10 is provided in the aforementioned flow path of recovery current. The short-circuit current due to the recovery current is suppressed by the auxiliary reactor 10. This can eliminate various drawbacks resulting from the recovery current and having conventionally been regarded as problems. Moreover, electrical energy stored in the auxiliary reactor 10 is discharged as the current is to the load 4 by turn-on of the auxiliary switching element 8, whereby the electrical energy is re-used as energy to be consumed by the load 4. This is conducive to saving energy.

Furthermore, each of the auxiliary switching element 8 and the auxiliary reactor 10 has a small current capacity. In particular, since the auxiliary reactor 10 has a small inductance, the auxiliary reactor 10 may have a small-sized structure such that a core is put alongside on a copper plate wired on a substrate.

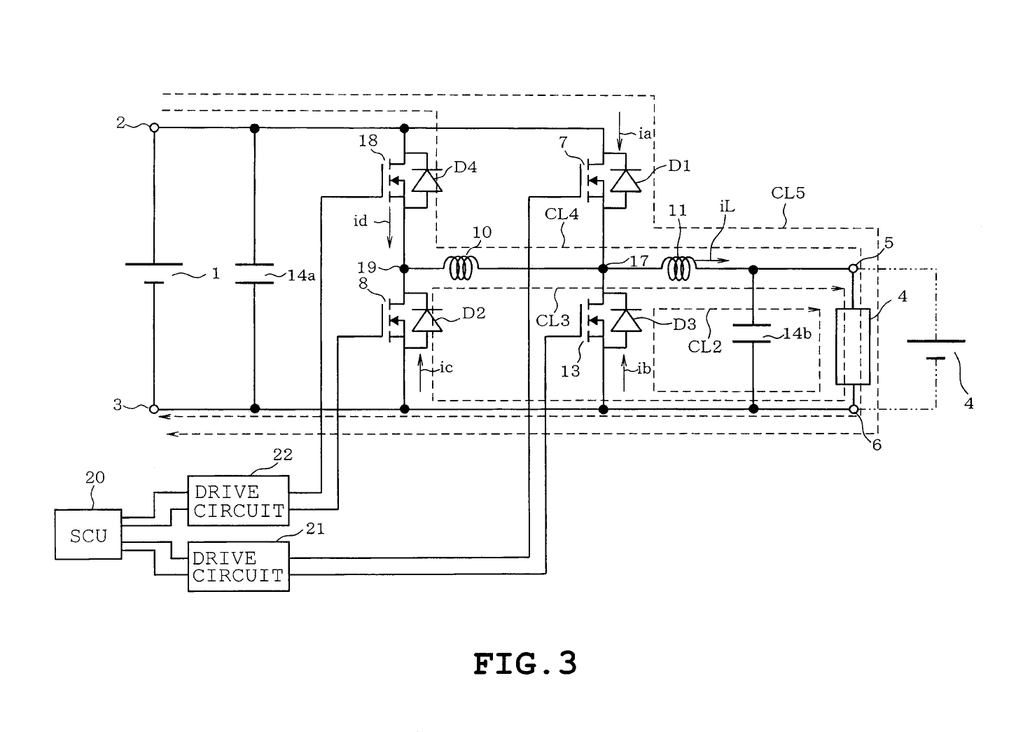

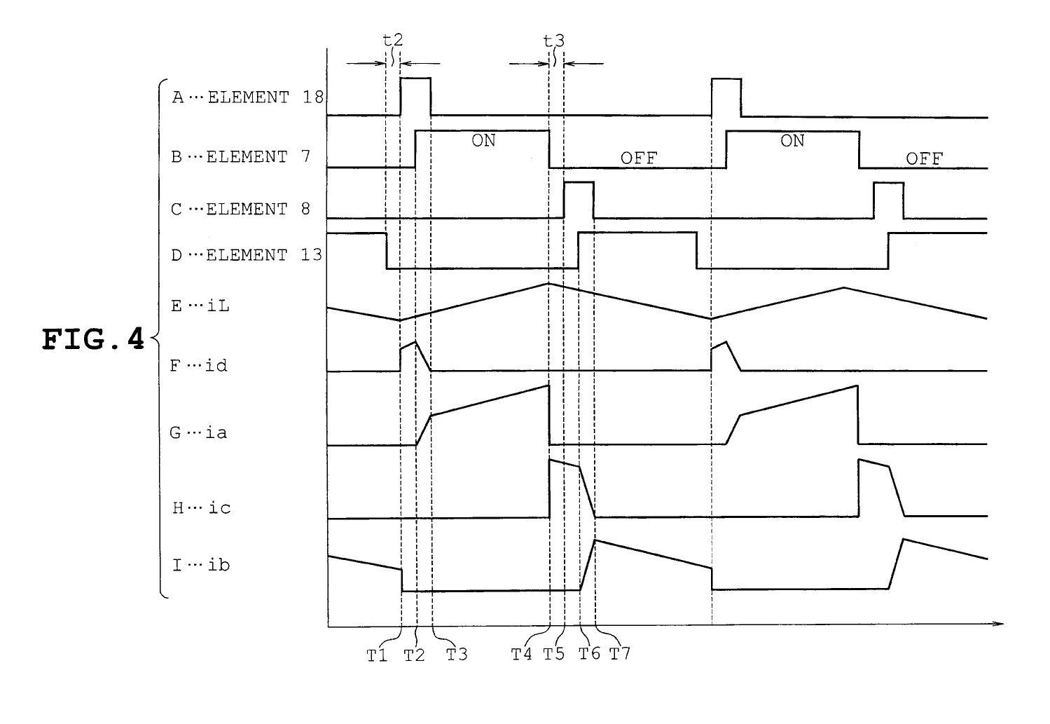

FIGS. 3 and 4 illustrate a second embodiment. In the configuration as shown in FIG. 3, components or parts identical or similar to those in the first embodiment are labeled by the same reference symbols as those in the first embodiment and the description of these components will be eliminated. The first main switching element 7 and the second main switching element 13 are connected in series to each other between the DC voltage positive and negative input terminals 2 and 3, so as to be located at the positive side and the negative side respectively. The main reactor 11 is connected between the common connection point 17 of the first and second main switching elements 7 and 13 and the DC voltage positive output terminal 5. A first auxiliary switching element 18 and the second auxiliary switching element 8 are connected in series to each other between the DC voltage positive and negative input terminals 2 and 3, so as to be located at the positive side and the negative side respectively. The auxiliary reactor 10 is connected between the common connection point 17 and a common connection point 19 of the first and second auxiliary elements 18 and 8.

The diode D4 is also connected in reverse parallel with the first auxiliary switching element 18. The DC-DC converter is further provided with a switching control unit (SCU) 20 on-off controlling the switching elements 7, 13, 18 and 8. The SCU 20 is configured with a microcomputer and generates gate control signals. The gate control signals include those supplied via a gate drive circuit 21 to the gates of the first and second main switching elements 7 and 13 and those supplied via a gate drive circuit 22 to the auxiliary switching elements 18 and B. The auxiliary reactor 10 may have a significantly smaller current capacity than the main reactor 11.

The working of the DC-DC converter thus configured will be described in detail as follows with reference to FIG. 4. The first and second main switching elements 7 and 13 are on-off controlled so that both switching elements 7 and 13 have phases opposed to each other, in the same manner as in the first embodiment, as shown in FIGS. 4-B and 4-D. The first auxiliary switching element 18 is turned on and is immediately thereafter turned off repeatedly preceding an on-period of the first main switching element 7 while the second main switching element 13 is in an off period, as shown in FIG. 4-A. The second main switching element 8 is turned on and is immediately thereafter turned off repeatedly preceding an on-period of the second main switching element 13 while the first main switching element 7 is in an off-period, as shown in FIG. 4-C.

Symbol “t2” in FIG. 4 designates a dead time interposed between turn-off of the second main switching element 13 and turn-on of the first auxiliary switching element 18. Symbol “t3” designates a dead time interposed between turn-off of the first main switching element 7 and turn-on of the second auxiliary switching element 8. A closed loop CL4 is formed when the first auxiliary switching element 18 is turned on at time T1 as shown in FIG. 4, so that current flows into the load 4 through the DC voltage positive input terminal 2, the first auxiliary switching element 18, the auxiliary reactor 10 and the main reactor 11. Subsequently, when the first main switching element 7 is turned on at time T2, a closed loop CL5 is formed with the result that current flows from the DC voltage positive input terminal 2 through the first main switching element 7 and the main reactor 11 to the load 4. FIG. 3 shows a battery serving as the load 4 as will be described later.

The closed loop CL3 similar to that in the first embodiment is formed when the first main switching element 7 is turned off at time T4 and the second auxiliary switching element 8 is subsequently turned on at time T5. Electrical energy is stored in the auxiliary reactor 10 by the on-off operation of the first auxiliary switching element 18. The electrical energy is discharged through the main reactor 11 to the load 4 side thereby to be used as energy to be consumed by the load 4. When the second main switching element 13 is turned on at time T6 immediately after time T5, the closed loop CL2 similar to that in the first embodiment is formed and electrical energy stored in the main reactor 11 is discharged to the load 4.

FIG. 4-E shows current iL passing through the main reactor 11 in the above-described operation. FIG. 4-F shows current passing through the first auxiliary switching element 18, that is, current id passing through the auxiliary reactor 10. FIG. 4-G shows current is passing through the first main switching element 7. FIG. 4-H shows current is passing through the second auxiliary switching element 8. FIG. 4-I shows current ib passing through the second main switching element 13. As understood from the foregoing, energization of the main reactor 11 is started through the first auxiliary switching element 18 which is turned on at time T1 preceding turn-on of the first main switching element 7. Recovery current passing through the diodes D4 and D3 in the reverse direction is generated at time T1. However, since the recovery current passes through the auxiliary reactor 10, the recovery current is prevented from becoming a short-circuit current.

In a series circuit of the first and second main switching elements 7 and 13 provided with respective diodes D1 and D3, the first auxiliary switching element 18 is in an ON state in a period between time T1 and time T2, in which period both switching elements 7 and 13 are turned off. Accordingly, no recovery current passing through the diodes D1 and D3 is generated. Furthermore, the newly added first and second auxiliary switching elements 18 and 8 also form a series circuit. In the same manner as described above, regarding the diodes D4 and D2 provided in the respective switching elements 18 and 8 in the series circuit, no recovery current flows through the diodes D4 and D2 since the current iL due to the back electromotive force of the main reactor 11 passes through the closed loop CL3 to the diode D2 in a period between time T4 and time T5, in which period both switching elements 18 and 8 are turned off.

One of the characteristics of the second embodiment over the first embodiment resides in the provision of the first auxiliary switching element 18 which is configured to be turned on preceding the ON operation of the first main switching element 7 and further in that energization of the main reactor 11 is time-divided to a first time period in which the energization of the main reactor 11 is carried out via the auxiliary reactor 10 and a second time period which follows the first time period and in which the energization of the main reactor 11 is carried out via the first main switching element 7 without via the auxiliary reactor 10.

The above-described configuration of the second embodiment can be used in a step-up power supply device provided in an electric car. More specifically, a low-voltage battery 4 of 12 volts serving as the load is connected to the DC-DC converter of the embodiment so that a positive electrode of the battery 4 serves as the DC positive output terminal 5. The low-voltage battery 4 serves as a power supply of low-voltage electrical equipment of the electric car. On the other hand, the DC power supply 1 is used as a high-voltage battery of 400 volts driving an assisting motor of the electric car. In the connecting configuration, when the first and second main switching elements 7 and 13 are on-off controlled in such a mode that an ON duty exceeds 50%, an emergency countermeasure can be realized in which the voltage of the low-voltage battery 4 is stepped up to 40 volts to replenish electric power with the high-voltage battery 1. The aforesaid first and second auxiliary switching elements 18 and 8 are associated with on-off operation of the first and second main switching elements 7 and 13 respectively, as described above.

As described above, according to each of the first and second embodiments, the DC-DC converter can be provided which can reliably suppress short-circuit current due to recovery current by a simple and cost-effective configuration that an auxiliary reactance and an auxiliary switching element each having small inductance and small current capacity and further in which current obtained as the result of suppression can be used as power to be consumed by the load.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A DC-DC converter comprising:
a main reactor interposed in a main energization path extending from a DC voltage input terminal to a DC voltage output terminal;
a first main switching element which is interposed in the main energization path so as to be on-off controlled so that current flowing across the main reactor is intermitted;
a second main switching element forming a discharge loop which discharges electrical energy stored in the main reactor to the DC voltage output terminal side;
an auxiliary reactor interposed between the first main switching element and the main reactor in the main energization path;
an auxiliary switching element which discharges electrical energy via the main reactor to the DC voltage output terminal side, the electrical energy being stored in the auxiliary and main reactors; and
a plurality of diodes connected in reverse parallel with the first and second main switching elements and the auxiliary switching elements respectively.

2. The DC-DC converter according to claim 1, wherein the auxiliary reactor has inductance with a time constant set at a value such that the time constant is not more than one period of an on/off cycle of the first main switching element.

3. The DC-DC converter according to claim 1, wherein the auxiliary reactor has a smaller current capacity than the main reactor.

4. The DC-DC converter according to claim 1, wherein the auxiliary reactor has a smaller current capacity than the main reactor.

5. The DC-DC converter according to claim 1, wherein the auxiliary switching element has a smaller current capacity than the first main switching element.

6. The DC-DC converter according to claim 2, wherein the auxiliary switching element has a smaller current capacity than the first main switching element.

7. A DC-DC converter comprising:
a DC voltage positive input terminal and a DC voltage negative input terminal;
a DC voltage positive output terminal and a DC voltage negative output terminal;
a first main switching element and an auxiliary switching element both of which are connected in series to each other between the positive and negative input terminals so as to be located at the positive and negative sides respectively;
an auxiliary reactor and a main reactor both of which are connected in series to each other between a common connection point of the first main and auxiliary switching elements and the positive output terminal, so as to be located at the common connection point side and the positive output terminal side respectively;
a second main switching element connected between a common connection point of both reactors and the negative output terminal; and
a plurality of diodes connected in reverse parallel with the main switching elements and the auxiliary switching element respectively.

8. A DC-DC converter comprising:
a DC voltage positive input terminal and a DC voltage negative input terminal;
a DC voltage positive output terminal and a DC voltage negative output terminal;
first and second main switching elements connected in series to each other between the positive and negative input terminals;
a main reactor connected between a common connection point of both main switching elements and the positive output terminal;
first and second auxiliary switching elements connected in series to each other between the positive and negative input terminals;
an auxiliary reactor connected between a common connection point of the first and second main switching elements and a common connection point of the first and second auxiliary switching elements; and
a plurality of diodes connected in reverse parallel with the main switching elements and the auxiliary switching elements respectively.

9. The DC-DC converter according to claim 8, wherein ON operations of the first and second auxiliary switching elements precede ON operations of the first and second main switching elements, and OFF operations of the first and second auxiliary switching elements precede OFF operations of the first and second main switching elements.

10. The DC-DC converter according to claim 8, wherein the auxiliary reactor has inductance set so that a time constant thereof is not more than one period of an on-off cycle of the first main switching element.

11. The DC-DC converter according to claim 9, wherein the auxiliary reactor has inductance set so that a time constant thereof is not more than one period of an on-off cycle of the first main switching element.

12. The DC-DC converter according to claim 8, wherein the first and second auxiliary switching elements have smaller electrical capacities than the first switching element respectively.

13. The DC-DC converter according to claim 9, wherein the first and second auxiliary switching elements have smaller electrical capacities than the first switching element respectively.

14. The DC-DC converter according to claim 8, wherein the auxiliary reactor has a smaller electrical capacity than the main reactor.

15. The DC-DC converter according to claim 9, wherein the auxiliary reactor has a smaller electrical capacity than the main reactor.
